(19) United States
(12) Patent Application Publication
(10) Pub. No.: US 2026/0264492 A1
(43) Pub. Date: Sep. 10, 2026

(54) ADJUSTABLE VEHICLE TONNEAU COVER

(71) Applicant: Ford Global Technologies, LLC, Dearborn, MI (US)

(72) Inventors: Stuart C. Salter, White Lake, MI (US); Dwayne Cammon, Bloomfield Twp., MI (US); Dawn Piechocki, Gross Pointe Park, MI (US); Hojun Ahn, Ann Arbor, MI (US); Laura Saneholtz, Berkley, MI (US); Wai-Sun Ronald Gin, LaSalle (CA)

(73) Assignee: Ford Global Technologies, LLC, Dearborn, MI (US)

(21) Appl. No.: 19/069,340

(22) Filed: Mar. 4, 2025

(51) Int. Cl. B60J 7/16; B62D 35/00

(52) U.S. Cl. CPC B60J 7/1614; B62D 35/007

(57) ABSTRACT

A vehicle tonneau cover for covering a bed of a pickup truck has a base frame, a connector assembly configured to couple the base frame to a bed rail, a top cover having a front end and a rear end and opposite side edges, and an actuator assembly operatively coupled to the front end of the cover to raise and lower the front end of the top cover. First and second side walls extend on opposite sides between the top cover and the base frame and between the front end and the rear end, each side wall having first and second panels and a first hinge coupled between the first and second panels. The first and second side walls at least partially fold when the cover is lowered.

### FIELD OF THE DISCLOSURE

The present disclosure generally relates to vehicle truck bed covers, and more particularly relates to a tonneau cover that may be adjusted to different positions.

### BACKGROUND OF THE DISCLOSURE

Motor vehicles such as pickup trucks are commonly equipped with bed covers that are often referred to as tonneau covers which are flexible or rigid covers that generally cover the cargo bed of the truck. Some tonneau covers may be rolled up or raised at the rear end to allow access to the cargo bed. It would be desirable to provide for a tonneau cover that may be reconfigured for enhanced vehicle efficiencies such as aerodynamics.

### SUMMARY OF THE DISCLOSURE

According to a first aspect of the present disclosure, a vehicle tonneau cover for covering a bed of a pickup truck has a base frame, a connector assembly configured to couple the base frame to a bed rail on the bed, a top cover having a front end and a rear end and opposite side edges and an actuator assembly operatively coupled to the front end of the cover to raise and lower the front end of the top cover. A first side wall extends on a first side between the top cover and the base frame and between the front end and the rear end, the first side wall having first and second panels and a first hinge coupled between the first and second panels. A second side wall extends on a second side between the top cover and the base frame and between the front end and the rear end. The second side wall has third and fourth panels and a second hinge coupled between the third and fourth panels. The first and second side walls at least partially fold when the cover is lowered.

Embodiments of the first aspect of the present disclosure can include any one or a combination of the following features:

a controller configured to control the actuator assembly to raise and lower the front end of the top cover based on vehicle speed;

the controller controls the actuator assembly to raise the top cover when the vehicle speed is greater than a first threshold and lowers the top cover when the vehicle speed is lower than a second threshold;

at least one fairing proximate to the front end of the top cover;

the fairing comprises a top panel interconnecting two side panels;

the front end of the top cover is proximate to an underside of the top panel in a raised position;

a seal disposed between the underside of the top panel and the front end of the top cover in the raised position;

the connector assembly comprises a rear support for supporting the rear end of the cover in a raised position;

the rear support comprises one or more prop rods;

the actuator assembly comprises one or more power struts;

the one or more power struts comprises first and second power struts;

the first side wall and the second side wall at least partially fold inwards towards each other;

first member covering on outer side of the first hinge and a second member covering on outer side of the second hinge;

the top cover comprises a rigid material;

the rigid material comprises a composite material;

the cover comprises a transparent window; and

each of the first and second side walls comprise three panels coupled to three hinges.

According to a second aspect of the present disclosure, a vehicle tonneau cover for covering a bed of a pickup truck has a base frame, a connector assembly configured to couple the base frame to a bed rail on the bed, a top cover having a front end and a rear end and opposite side edges and an actuator assembly operatively coupled to the front end of the cover to raise and lower the front end of the top cover. A first side wall extends on a first side between the top cover and the base frame and between the front end and the rear end. The first side wall has first, second and third panels and first, second and third hinges coupling the first, second and third panels with the top cover and base frame. A second side wall extends on a second side between the top cover and the base frame and between the front end and the rear end. The second side wall has fourth, fifth and sixth panels and fourth, fifth and sixth hinges coupling the fourth, fifth and sixth panels. The first and second side walls at least partially fold when the top cover is lowered.

Embodiments of the second aspect of the present disclosure can include the following feature:

a controller configured to control the actuator assembly to raise and lower the front end of the top cover based on vehicle speed.

According to a third aspect of the present disclosure, a vehicle has a body defining a bed having a bed rail and a vehicle tonneau cover for covering the bed. The tonneau cover has a base frame, a connector assembly configured to couple the base frame to the bed rail on the bed, a top cover having a front end and a rear end and opposite side edges and an actuator assembly operatively coupled to the front end of the cover to raise and lower the front end of the top cover. A first side wall extends on a first side between the top cover and the base frame and between the front end and the rear end, the first side wall having first and second panels and a first hinge coupled between the first and second panels. A second side wall extends on a second side between the top cover and the base frame and between the front end and the rear end. The second side wall has third and fourth panels and a second hinge coupled between the third and fourth panels. The first and second side walls at least partially fold when the cover is lowered.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper rear perspective view of a motor vehicle in the form of a pickup truck having an adjustable tonneau cover arranged in a front end raised position covering a cargo bed, according to one embodiment;

FIG. 2 is a rear view of the motor vehicle illustrating the adjustable tonneau cover in the raised position on the front end as shown in FIG. 1;

FIG. 3 is an upper rear perspective view of the motor vehicle bed with the adjustable tonneau cover arranged in a lowered position on the front end;

FIG. 4 is an upper side perspective view of the vehicle bed with the adjustable tonneau cover arranged in a raised position on the rear end;

FIG. 5 is an enlarged view of a portion of the adjustable tonneau cover in the raised position as shown in FIG. 4;

FIG. 5A is an enlarged view of section VA illustrating a linkage assembly for the connecting assembly, according to one example; and

FIG. 6 is a logic diagram illustrating a controller for controlling the adjustable tonneau cover, according to one example.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

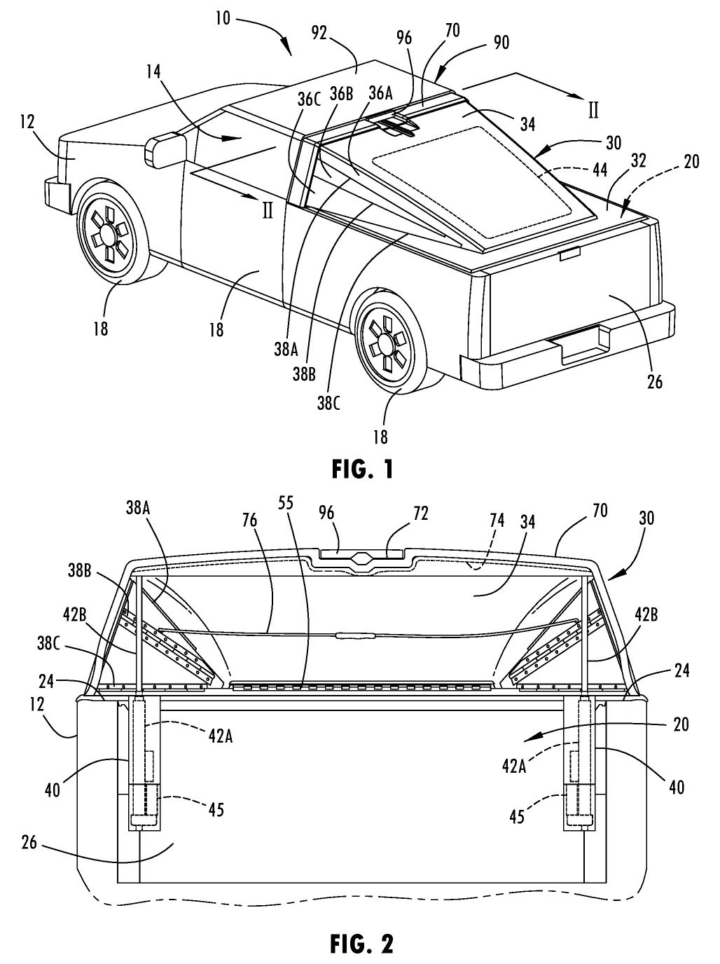

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an adjustable vehicle tonneau cover. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-6, a motor vehicle 10 is generally illustrated in the form of a pickup truck equipped with an adjustable tonneau cover 30 configured to cover a cargo bed of the pickup truck. The tonneau cover 30 includes a base frame 32 and a connector assembly configured to couple the base frame to a bed rail 24 on the bed of the truck and a top cover 34 having a front end and a rear end and opposite side edges. The vehicle tonneau cover 30 has an actuator assembly operatively coupled to the front end of the top cover to raise and lower the front end of the top cover. A first side wall extends on a first side between the front end and the rear end and has first and second panels and at least one hinge coupled between the first and second panels. A second side wall extends on a second side between the top cover and the base frame and between the front end and the rear end that has third and fourth panels and at least one hinge coupled between the third and fourth panels, wherein the first and second panels and the third and fourth panels fold and extend to allow the front end of the tonneau cover 30 to move between raised and lowered positions.

With particular reference to FIG. 1, the motor vehicle 10 is generally shown having a vehicle body 12 defining an interior cabin, referred to as a passenger compartment 14. The passenger compartment 14 is generally defined by a vehicle cab 90. The motor vehicle 10 is shown and described herein as a motor vehicle in the form of a pickup truck having the vehicle cab 90 generally in the middle portion of the motor vehicle 10 and a pickup truck cargo bed 20 generally provided at the rear end portion of the motor vehicle 10. The passenger compartment 14 within the vehicle cab 90 is typically configured with a seating arrangement which may include one or more rows of seating and driver controls and accessories.

The motor vehicle 10 is shown as a wheeled motor vehicle having a plurality of tire and wheel assemblies 18 supporting the body 12. The vehicle body 12 also includes access doors 16 shown on opposite lateral left and right sides of the motor vehicle 10 proximate to the cab 90 and a roof 92 which forms a top of the cab 90. The vehicle cab 90 also includes a rear wall, which may include a rear window 94, shown in FIG. 4. The pickup truck cargo bed 20 as shown in FIG. 4 is generally rectangular and includes a front wall 28 which may be formed proximate to the rear wall of the vehicle cab 90 at the front end, lateral side walls 22 on opposite left and right sides and a tailgate 26 at the rear end. The tailgate 26 may pivot about pivot hinges on a lower end between open and closed positions to allow rear end access to the cargo bed 20. The cargo bed 20 further includes a horizontal bed rail 24 on top extending around the upper perimeter of the cargo bed 20. It should be appreciated that the motor vehicle 10 may include the horizontal bed rail 24 or may further include a separate frame provided on top of the bed rail 24 to further support the tonneau cover 30.

The vehicle tonneau cover 30 may be connected onto the pickup truck cargo bed 20 via a connector assembly connected to the bed rail 24 to fixedly secure the tonneau cover 30 on the bed 20. The vehicle tonneau cover 30 includes a base frame 32 that is supported on top of the bed rail 24, according to one embodiment. It is conceivable that the bed rail 24 may be configured as the base frame 32 to support the vehicle tonneau cover 30 according to other embodiments. The top cover 34 serves as the covering that covers a substantial portion of the bed 20. The top cover 34 pivotally connects to the base frame 32 at the front end via a pair of linkage assemblies 120 which serve as part of the connector assembly. The linkage assemblies 120 are located on opposite lateral sides of the base frame 32 and top cover 34 at the front end. The top cover 34 is shown in FIGS. 1 and 2 in an elevated position at the front end in which the front end of the top cover 34 is raised proximate to a height of the roof 92 of the motor vehicle 10 or slightly below the roof 92. The rear end of the top cover 34 remains connected to the base frame 32.

The tonneau cover 30 has a plurality of side panels on each of the left and right lateral sides. The plurality of side panels includes at least a first panel and a second panel connected via one or more hinges to allow the plurality of side panels to fold as the top cover 34 moves between an elevated position and a lowered position. In the example shown, the plurality of side panels on each lateral side includes a first panel 36A, a second lower panel 36B and a third lower panel 36C. The first and second panels 36A and 36B are coupled via a first hinge 38A that generally extends from a forward end towards a rear end of the tonneau cover 30. The second panel 36B and third panel 36C are coupled together via a second hinge 38B which likewise extends from a forward end towards the rear end. The third panel 36C is coupled to the base frame 32 via a third hinge 38C which likewise extends from the front end towards the rear end. It should be appreciated each of the left and right sides have a similar panel arrangement of multiple panels and one or more hinges extending between the top cover 34 and the base frame 32 and the side walls fold to move closer together in lowered positions. The top cover 34 and the first, second and third panels 36A, 36B and 36C may be made of a composite material such as a rigid material of fibers and polymer, for example. According to other examples, flexible fabric or vinyl may be used. The first, second and third hinges 38A, 38B and 38C may be configured as spring hinges with defroster tape and may be covered with flexible material to provide a waterproof covering.

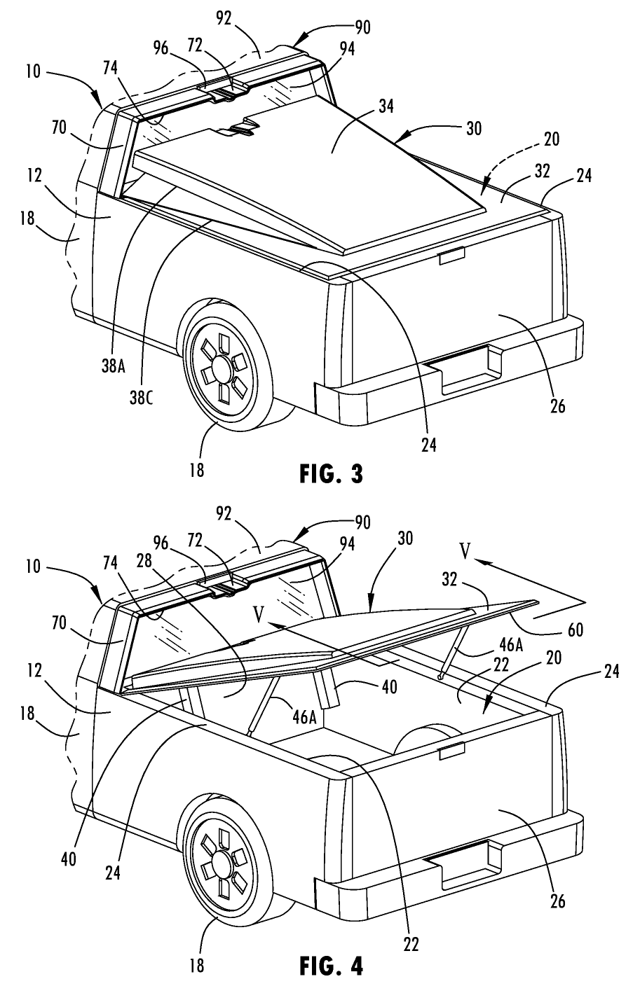

The tonneau cover 30 is configured to be actuated to move vertically at the front end between a raised elevated position as shown in FIGS. 1 and 2 and a lower position as shown in FIG. 3. The top cover 34 may include a transparent window 44 to allow viewing through the rear window 94 with the top cover 34 in the raised position. When this occurs, the top cover 34 is actuated between the raised and lowered positions via a pair of actuators, referred to as a pair of power struts 40, each having an actuator rod 42 and an electric motor 45, and the top cover 34 pivots about the rear end at rear hinge 55. The pair of power struts 40 may each be actuated via a corresponding motor such as an electric motor 45 that is controlled by a controller to raise and lower the actuator rods 42 in a telescoping movement. It should be appreciated that the tonneau cover 30 may be configured to move between the raised and lowered positions based on vehicle driving factors such as vehicle speed so as to enhance the vehicle aerodynamics and enhance the energy efficiency of the motor vehicle 10. It should further be appreciated that the actuators such as the pair of power struts 40 may be actuated to raise and lower the top cover 34 to accommodate the clearance height at the front end needed to cover cargo within the pickup truck cargo bed 20.

In order to bias the side panels to fold inwardly, the tonneau cover 30 may include a biasing mechanism such as a bungee cord 76 or a spring extending under tension between the opposing side walls. The bungee cord 76 may be coupled to the inner side of the side walls at or proximate to the middle hinge 30B.

The motor vehicle 10 is shown having a fairing 70 with walls extending vehicle rearward from the rear end of the cab 90 which may enhance aerodynamics of the motor vehicle 10. The fairing 70 has two side panels extending along the sides and a top panel on top extending rearward from the cab 90 such that it partially covers the front end and sides of the tonneau cover 30. A seal 74, such as a bulb seal, may extend between the top cover 34 and the fairing 70 to provide a weatherproof seal when the top corner 34 is positioned proximate the fairing 70.

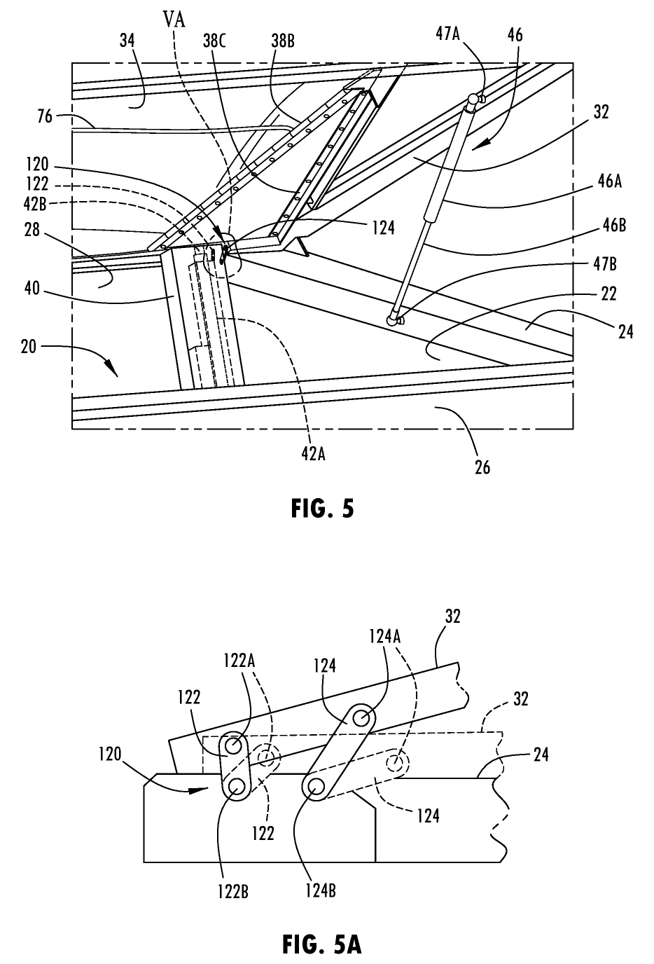

The tonneau cover 30 is further configured to be raised at the rear end to allow access to the bed 20 as shown in FIG. 4. With the tonneau cover 30 elevated at the rear end, a pair of prop rods 46 provided on opposite left and right sides may hold the tonneau cover 30 in the extended elevated position. The prop rods 46 are part of the connector assembly that supports the tonneau cover 30 on the bed rail 24. Each prop rod 46 has a lower rod 46B that telescopes within an upper cylinder 46A in one example. The prop rod 46 is further illustrated in FIG. 5 with one end 47A connected to the top cover 34 and the opposite end 47B connected to the bed rail 24. The prop rods 46 may hold the tonneau cover 30 in the elevated position once a user raises the tonneau cover 30 at the rear end. In the example shown, the prop rods 46 are manually actuable. However, it should further be appreciated that the tonneau cover 30 could be actuated via a motor coupled to one or both of the prop rods 46 to raise and lower the rear end of the tonneau cover 30.

The connector assembly further includes a linkage assembly 120 located proximate to the left and right front sides of the base frame 32 and connected to the bed rail 24 on opposite sides. The linkage assembly 20 is further illustrated in FIG. 5A having a first link 120 coupled to the base frame 32 and the bed rail 24 via pivot pins 122A and 122B, respectively. The linkage assembly 120 also includes a second link 124 which is likewise connected between the base frame 32 and the bed rail 24 via pivot pins 124A and 124B, respectively. The second link 124 is longer than the first link 122 and is located vehicle rearward to allow for rotation of the base frame 32 upward at the rear end. As such, the pair of linkage assemblies 120 and the pair of prop rods 46 provide the connector assembly for connecting the tonneau cover 30 onto the vehicle bed, particularly onto the bed rail 24.

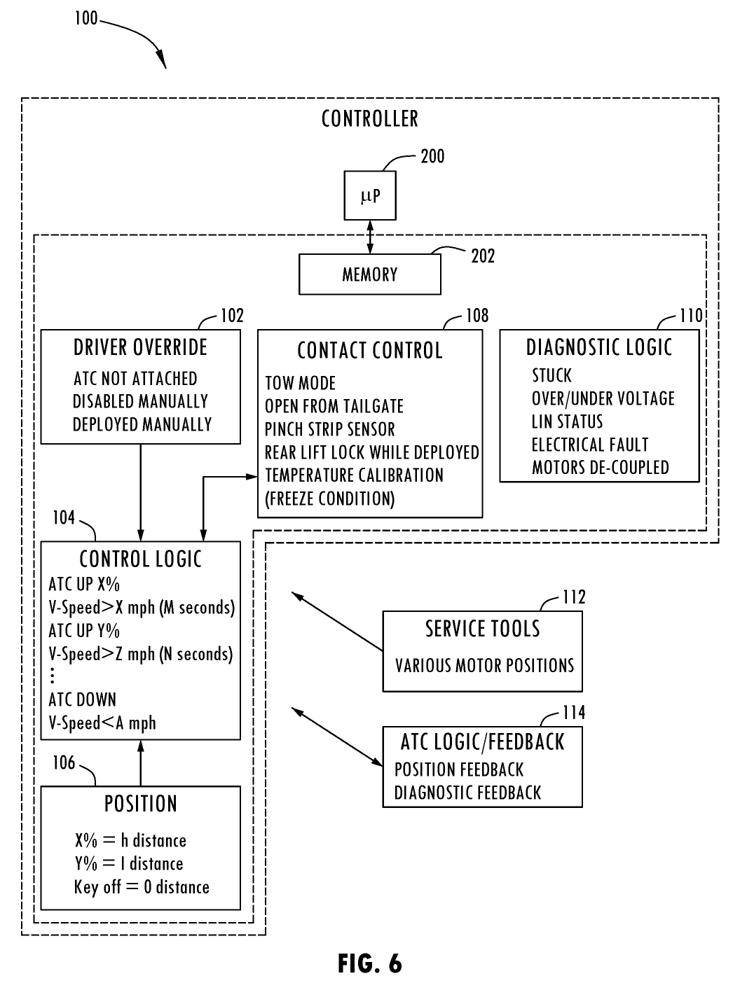

Referring to FIG. 6, the tonneau cover 30 may be actuated to various adjustable positions in a controlled manner as shown according to one example. In doing so, the tonneau cover 30 includes a controller 100 that may control actuation of the pair of power struts 40 via the pair of motors 45 to raise and lower the front end of the tonneau cover 30 to enhance vehicle travel and efficiency with the tonneau cover 30. The controller 100 may include a microprocessor 200 and memory 202 storing one or more routines with control logic that is executable by the microprocessor 200, according to one example. It should be appreciated that the controller 100 may include other analog and/or digital control circuitry and may be a dedicated or shared controller.

In the example shown, the controller 100 may be actuated to control movement of the tonneau cover 30 into various configurations and height positions. The controller 100 may process driver override logic 102 which may be overridden by a driver of the motor vehicle 10 such that the motor controlled actuation of the tonneau cover 30 between raised and lowered positions is disabled and manual operation is enabled. The controller 100 may employ control logic 104 that may raise the tonneau cover 30 at the front end when the vehicle speed is greater than a predefined vehicle speed of X. The tonneau cover 30 may be raised to a second height when the vehicle speed exceeds a greater second speed Y. The tonneau cover 30 may be lowered at the front end when the vehicle speed is less than a third vehicle speed A. It should be appreciated that the position of the tonneau cover 30 may be adjusted in height depending on vehicle speed and sensed position of the tonneau cover 30 from position logic 106 to enhance the vehicle aerodynamics and energy efficiency of the motor vehicle 10.

The controller 100 may include contact control logic 108 that may detect an open tailgate or a pinched strip sensor detecting potential contact with an object or a rear lift lock while deployed, for example. Diagnostic logic 110 may be employed to determine if the tonneau cover 30 is stuck in a position, or is sustaining an over- or under-voltage, or experiences a LIN status, an electrical fault or motors that are decoupled. The diagnostic logic 110 may disable any automatic or motor actuated movement of the tonneau cover 30.

The controller 100 may further communicate with one or more service tools 112 such as to acquire various motor positions. In addition, the controller 100 may communicate with ATC logic/feedback 114 to acquire position and diagnostic feedback. The controller 100 may utilize the position and feedback to control movement of the tonneau cover 30.

Accordingly, the tonneau cover 30 is provided for a pickup truck cargo bed that allows the tonneau cover 30 to be adjusted in height, particularly on the front end. The position or configuration of the tonneau cover 30 may advantageously be adjusted based on vehicle speed as the motor vehicle 10 is driving to achieve enhanced aerodynamics and energy efficiency of the motor vehicle 10.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle tonneau cover for covering a bed of a pickup truck, the tonneau cover comprising:
a base frame;
a connector assembly configured to couple the base frame to a bed rail on the bed;
a top cover having a front end and a rear end and opposite side edges;
an actuator assembly operatively coupled to the front end of the top cover to raise and lower the front end of the top cover;
a first side wall extending on a first side between the top cover and the base frame and between the front end and the rear end, the first side wall having first and second panels and a first hinge coupled between the first and second panels; and
a second side wall extending on a second side between the top cover and the base frame and between the front end and the rear end, the second side wall having third and fourth panels and a second hinge coupled between the third and fourth panels, wherein the first and second side walls at least partially fold when the cover is lowered.

2. The vehicle tonneau cover of claim 1, further comprising a controller configured to control the actuator assembly to raise and lower the front end of the top cover based on vehicle speed.

3. The vehicle tonneau cover of claim 2, wherein the controller controls the actuator assembly to raise the top cover when the vehicle speed is greater than a first threshold and lowers the top cover when the vehicle speed is lower than a second threshold.

4. The vehicle tonneau cover of claim 1, further comprising at least one fairing proximate to the front end of the top cover.

5. The vehicle tonneau cover of claim 4, wherein the fairing comprises a top panel interconnecting two side panels.

6. The vehicle tonneau cover of claim 5, wherein the front end of the top cover is proximate to an underside of the top panel in a raised position.

7. The vehicle tonneau cover of claim 6, further comprising a seal disposed between the underside of the top panel and the front end of the top cover in the raised position.

8. The vehicle tonneau cover of claim 1, wherein the connector assembly comprises a rear support for supporting the rear end of the cover in a raised position.

9. The vehicle tonneau cover of claim 8, wherein the rear support comprises one or more prop rods.

10. The vehicle tonneau cover of claim 1, wherein the actuator assembly comprises one or more power struts.

11. The vehicle tonneau cover of claim 10, wherein the one or more power struts comprises first and second power struts.

12. The vehicle tonneau cover of claim 5, wherein the first side wall and the second side wall at least partially fold inwards towards each other.

13. The vehicle tonneau cover of claim 1, further comprising first member covering on outer side of the first hinge and a second member covering on outer side of the second hinge.

14. The vehicle tonneau cover of claim 1, wherein the top cover comprises a rigid material.

15. The vehicle tonneau cover of claim 14, wherein the rigid material comprises a composite material.

16. The vehicle tonneau cover of claim 1, wherein the cover comprises a transparent window.

17. The vehicle tonneau cover of claim 1, wherein each of the first and second side walls comprise three panels coupled to three hinges.

18. A vehicle tonneau cover for covering a bed of a pickup truck, the tonneau cover comprising:
a base frame;
a connector assembly configured to couple the base frame to a bed rail on the bed;
a top cover having a front end and a rear end and opposite side edges;
an actuator assembly operatively coupled to the front end of the top cover to raise and lower the front end of the top cover;
a first side wall extending on a first side between the top cover and the base frame and between the front end and the rear end, the first side wall having first, second and third panels and first, second and third hinges coupling the first, second and third panels with the top cover and base frame; and
a second side wall extending on a second side between the top cover and the base frame and between the front end and the rear end, the second side wall having fourth, fifth and sixth panels and fourth, fifth and sixth hinges coupling the fourth, fifth and sixth panels, wherein the first and second side walls at least partially fold when the top cover is lowered.

19. The vehicle tonneau cover of claim 18, further comprising a controller configured to control the actuator assembly to raise and lower the front end of the top cover based on vehicle speed.

20. A vehicle comprising:
a body defining a bed having a bed rail; and
a vehicle tonneau cover for covering the bed, the tonneau cover comprising:
a base frame;
a connector assembly configured to couple the base frame to the bed rail on the bed;
a top cover having a front end and a rear end and opposite side edges;
an actuator assembly operatively coupled to the front end of the top cover to raise and lower the front end of the top cover;
a first side wall extending on a first side between the top cover and the base frame and between the front end and the rear end, the first side wall having first and second panels and a first hinge coupled between the first and second panels; and
a second side wall extending on a second side between the top cover and the base frame and between the front end and the rear end, the second side wall having third and fourth panels and a second hinge coupled between the third and fourth panels, wherein the first and second side walls at least partially fold when the cover is lowered.
